(19) United States
(12) Patent Application Publication
(10) Pub. No.: US 2026/0281940 A1
(43) Pub. Date: Sep. 17, 2026

(54) COMMUNICATION METHOD AND APPARATUS

(71) Applicant: HUAWEI TECHNOLOGIES CO., LTD., Shenzhen (CN)

(72) Inventors: Yan Xi, Shanghai (CN); Xueqiang Yan, Shanghai (CN); Mingyu Zhao, Shanghai (CN); Junfan Wang, Shanghai (CN)

(73) Assignee: HUAWEI TECHNOLOGIES CO., LTD., Shenzhen (CN)

(21) Appl. No.: 19/676,119

(22) Filed: May 13, 2026

Related U.S. Application Data
(63) Continuation of application No. PCT/CN2024/130595, filed on Nov. 7, 2024.

(30) Foreign Application Priority Data
Nov. 14, 2023 (CN) 202311523195.3

(51) Int. Cl. H04W 60/04; H04W 8/20; H04W 48/16

(52) U.S. Cl. CPC H04W 60/04; H04W 8/205; H04W 48/16

(57) ABSTRACT

Embodiments of this application disclose a communication method and apparatus, relating to the field of communication technologies, aiming to address the complexity of enabling a data service function on a terminal device. The method includes: when detecting that a data service function is enabled, obtaining address information of a data controller, where the data controller is configured to manage the data service function of a terminal device; and sending first indication information to the data controller based on the address information of the data controller, where the first indication information is used to register a data service capability of the terminal device with the data controller. Embodiments of this application are applied to a data service process.

### CROSS-REFERENCE TO RELATED APPLICATIONS

This application is a continuation of International Application No. PCT/CN2024/130595, filed on Nov. 7, 2024, which claims priority to Chinese Patent Application No. 202311523195.3, filed on Nov. 14, 2023. The disclosures of the aforementioned applications are hereby incorporated by reference in their entireties.

### TECHNICAL FIELD

Embodiments of this application relate to the field of communication technologies, and in particular, to a communication method and apparatus.

### BACKGROUND

In communication networks, terminal devices may act as data producers, providers, or consumers for data services. Currently, however, enabling data services requires users to visit an operator's physical store or navigate through an operator's app, resulting in a cumbersome process.

### SUMMARY

Embodiments of this application provide a communication method and apparatus that reduce the complexity of enabling data services on terminal devices.

To achieve the foregoing objective, this application provides following technical solutions:

According to a first aspect, a communication method is provided. The method may be performed by a terminal device, or may be performed by a component of the terminal device, for example, a processor, a chip, or a chip system of the terminal device, or may be implemented by a logical module or software that can implement all or a part of the terminal device. An example in which the method is performed by a terminal device is used below for description. The communication method includes: when detecting that a data service function is enabled, obtaining address information of a data controller, where the data controller is configured to manage the data service function of the terminal device; and sending first indication information to the data controller based on the address information of the data controller, where the first indication information is used to register a data service capability of the terminal device with the data controller.

In this embodiment of this application, when detecting that the data service function is enabled, the terminal device obtains the address information of the data controller and registers the data service capability of the terminal device with the data controller. In this way, when a user needs to enable the data service function, the user can enable the data service function only by performing an operation on the terminal device, and does not need to perform an operation in an operator's business hall or perform an operation in an operator app. This reduces complexity of the operation performed when the data service function is enabled on the terminal device.

With reference to the first aspect, in a possible implementation, obtaining the address information of the data controller includes: receiving second indication information from an access and mobility management network element, where the second indication information indicates the address information of the data controller; or reading pre-configured address information of the data controller from the terminal device; or reading pre-configured address information of the data controller from an identity card of the terminal device.

Based on this, the terminal device may determine the address information of the data controller in different manners, thereby improving flexibility of obtaining the address information of the data controller by the terminal device.

With reference to the first aspect, in a possible implementation, before receiving the second indication information from the access and mobility management network element, the method further includes: sending third indication information to the access and mobility management network element, where the third indication information indicates to obtain the address information of the data controller.

Based on this, the terminal device sends a request message for obtaining the address information of the data controller to the access and mobility management network element, so that the access and mobility management network element can feed back the address information of the data controller to the terminal device based on the request message.

With reference to the first aspect, in a possible implementation, the third indication information is carried in a packet data unit (PDU) session establishment request message, and the second indication information is carried in a PDU session establishment response message.

Based on this, in a process of establishing a PDU session with the access and mobility management network element, the terminal device may obtain the address information of the data controller through the PDU session establishment request message and the PDU session establishment response message.

With reference to the first aspect, in a possible implementation, before sending the third indication information to the access and mobility management network element, the method further includes: sending a first registration request message to the access and mobility management network element, where the first registration request message indicates that the terminal device supports the data service capability; and receiving a first registration accept message from the access and mobility management network element, where the first registration accept message indicates that a network side supports the data service capability.

Based on this, when both the terminal device and the network side support the data service capability, the terminal device requests to obtain the address information of the data controller from the access and mobility management network element, so as to avoid that after the terminal device obtains the address information of the data controller, a data service cannot be performed because the network side does not support the data service capability.

According to a second aspect, a communication method is provided. The method may be performed by a terminal device, or may be performed by a component of the terminal device, for example, a processor, a chip, or a chip system of the terminal device, or may be implemented by a logical module or software that can implement all or a part of the terminal device. An example in which the method is performed by a terminal device is used below for description. The communication method includes: when detecting that a data service function is disabled, sending fourth indication information to a data controller, where the fourth indication information is used to deregister a data service capability of the terminal device from the data controller.

In this embodiment of this application, when detecting that the data service function is disabled, the terminal device deregisters the data service capability of the terminal device from the data controller. In this way, when a user needs to disable the data service function, the user only needs to perform an operation on the terminal device to disable the data service function, and does not need to perform an operation in an operator's business hall or perform an operation in an operator app. This reduces complexity of the operation performed when the data service function is disabled on the terminal device. In addition, in this embodiment of this application, the user may enable or disable the data service function on the terminal device, so that flexibility of using the data service capability by the terminal device can be greatly improved.

With reference to the second aspect, in a possible implementation, the method further includes: sending a second registration request message to the access and mobility management network element, where the second registration request message indicates that the terminal device does not support the data service capability.

Based on this, after detecting that the data service function is disabled, the terminal device can indicate, to the access and mobility management network element, that the terminal device does not support the data service capability, thereby ensuring consistency between the terminal side and the network side regarding whether the terminal device supports the data service capability.

With reference to the second aspect, in a possible implementation, the method further includes: sending a packet data unit (PDU) session release request message to the access and mobility management network element; receiving a PDU session release command message from the access and mobility management network element; and sending a PDU session release complete message to the access and mobility management network element.

Based on this, the terminal device can request to release a PDU session after detecting that the data service function is disabled, to avoid occupying a session resource in a network.

According to a third aspect, a communication method is provided. The method may be performed by an access and mobility management network element, or may be performed by a component of the access and mobility management network element, for example, a processor, a chip, or a chip system of the access and mobility management network element, or may be implemented by a logical module or software that can implement all or a part of the access and mobility management network element. The following uses an example in which the method is performed by an access and mobility management network element for description. The communication method includes: receiving third indication information from a terminal device, where the third indication information indicates to obtain address information of a data controller; and sending second indication information to the terminal device, where the second indication information indicates the address information of the data controller.

Based on this, the access and mobility management network element may feed back the address information of the data controller to the terminal device based on a request message sent by the terminal device for obtaining the address information of the data controller.

With reference to the third aspect, in a possible implementation, before sending the second indication information to the terminal device, the method further includes: sending a first request message to a session management network element, where the first request message is used to request to obtain the address information of the data controller; and receiving a first response message from the session management network element, where the first response message indicates the address information of the data controller.

Based on this, the access and mobility management network element may obtain the address information of the data controller from the session management network element.

With reference to the third aspect, in a possible implementation, the third indication information is carried in a packet data unit (PDU) session establishment request message, the second indication information is carried in a PDU session establishment response message, the first request message is carried in a PDU session context establishment request message, and the first response message is carried in a message in an N1N2 message transfer procedure.

Based on this, in a process of establishing a PDU session with the access and mobility management network element, the terminal device may obtain the address information of the data controller through the PDU session establishment request message and the PDU session establishment response message. The access and mobility management network element may obtain the address information of the data controller in a PDU session context creation procedure and the N1N2 message transfer procedure with the session management network element.

According to a fourth aspect, a communication apparatus is provided to implement the foregoing methods. The communication apparatus may be the terminal device in the first aspect or any implementation of the first aspect, or an apparatus including the foregoing terminal device, or an apparatus, for example, a chip, included in the foregoing terminal device. Alternatively, the communication apparatus may be the terminal device in the second aspect or any implementation of the second aspect, or an apparatus including the terminal device, or an apparatus, for example, a chip, included in the terminal device. Alternatively, the communication apparatus may be the access and mobility management network element in the third aspect or any implementation of the third aspect, or an apparatus including the access and mobility management network element, or an apparatus, for example, a chip, included in the access and mobility management network element. The communication apparatus includes a corresponding module, unit, or means for implementing the foregoing method. The module, unit, or means may be implemented by hardware, software, or hardware executing corresponding software. The hardware or the software includes one or more modules or units corresponding to the foregoing functions.

In some possible designs, the communication apparatus may include a processing module and a transceiver module. The transceiver module may also be referred to as a transceiver unit, and is configured to implement a sending function and/or a receiving function in any one of the foregoing aspects and any one of the possible implementations of the foregoing aspects. The transceiver module may include a transceiver circuit, a transceiver machine, a transceiver, or a communication interface. The processing module may be configured to implement a processing function in any one of the foregoing aspects and any one of the possible implementations of the foregoing aspects.

In some possible designs, the transceiver module includes a sending module and a receiving module, respectively configured to implement the sending function and the receiving function in any one of the foregoing aspects and any one of the possible implementations of the foregoing aspects.

According to a fifth aspect, a communication apparatus is provided, including at least one processor, where the processor is configured to execute a computer program or instructions stored in a memory, to enable the communication apparatus to perform the method according to any one of the foregoing aspects. The memory may be coupled to the processor, or may be independent of the processor. The communication apparatus may be the terminal device in the first aspect or any implementation of the first aspect, or an apparatus including the foregoing terminal device, or an apparatus, for example, a chip, included in the foregoing terminal device. Alternatively, the communication apparatus may be the terminal device in the second aspect or any implementation of the second aspect, or an apparatus including the terminal device, or an apparatus, for example, a chip, included in the terminal device. Alternatively, the communication apparatus may be the access and mobility management network element in the third aspect or any implementation of the third aspect, or an apparatus including the access and mobility management network element, or an apparatus, for example, a chip, included in the access and mobility management network element.

In some possible designs, the communication apparatus includes a memory, and the memory is configured to store necessary program instructions and data.

In a possible implementation, the processor includes a logic circuit and an input interface and/or an output interface. The output interface is configured to perform a sending action in a corresponding method, and the input interface is configured to perform a receiving action in a corresponding method.

In a possible implementation, the communication apparatus further includes a communication interface and a communication bus, and the processor, the memory, and the communication interface are connected through the communication bus. The communication interface is configured to perform a sending and receiving action in a corresponding method. The communication interface may also be referred to as a transceiver. Optionally, the communication interface includes a transmitter or a receiver. In this case, the transmitter is configured to perform the sending action in the corresponding method, and the receiver is configured to perform the receiving action in the corresponding method.

In some possible designs, when the communication apparatus is a chip system, the apparatus may include a chip, or may include a chip and another discrete device.

It may be understood that when the communication apparatus in any one of the fourth aspect and the fifth aspect is a chip, the foregoing sending action/function may be understood as output, and the foregoing receiving action/function may be understood as input.

According to a sixth aspect, a computer-readable storage medium is provided. The computer-readable storage medium stores a computer program or instructions. When the computer program or the instructions are run on a communication apparatus, the communication apparatus is enabled to perform the method according to any one of the foregoing aspects or any one of the implementations of the foregoing aspects.

According to a seventh aspect, a computer program product including instructions is provided. When the computer program product is run on a communication apparatus, the communication apparatus is enabled to perform the method according to any one of the foregoing aspects or any one of the implementations of the foregoing aspects.

According to an eighth aspect, a communication system is provided. The communication system includes the terminal device in the first aspect or any implementation of the first aspect and the access and mobility management network element in the third aspect or any implementation of the third aspect; or the communication system includes the terminal device in the second aspect or any implementation of the second aspect and the access and mobility management network element in the third aspect or any implementation of the third aspect.

For technical effect brought by any implementation in the fourth aspect to the eighth aspect, refer to technical effect brought by corresponding implementations in the first aspect or the second aspect or the third aspect. Details are not described herein again.

It should be noted that various possible implementations of any one of the foregoing aspects may be combined provided that the solutions are not contradictory.

### BRIEF DESCRIPTION OF DRAWINGS

FIG. 1 is a diagram of a system architecture of a 6G data plane according to an embodiment of this application;

FIG. 2 is a diagram of a system architecture of a communication system according to an embodiment of this application;

FIG. 3 is a diagram of a system architecture of another communication system according to an embodiment of this application;

FIG. 4 is a schematic flowchart of a communication method according to an embodiment of this application;

FIG. 5 is a diagram of an interface on which a terminal device shows a data service function switch according to an embodiment of this application;

FIG. 6 is a schematic flowchart of another communication method according to an embodiment of this application;

FIG. 7 is a schematic flowchart of another communication method according to an embodiment of this application;

FIG. 8 is a schematic flowchart of another communication method according to an embodiment of this application;

FIG. 9 is a schematic flowchart of another communication method according to an embodiment of this application;

FIG. 10 is a schematic flowchart of another communication method according to an embodiment of this application;

FIG. 11 is a diagram of a structure of a communication apparatus according to an embodiment of this application; and

FIG. 12 is a diagram of a structure of hardware of a communication apparatus according to an embodiment of this application.

### DESCRIPTION OF EMBODIMENTS

In the description of this application, unless otherwise specified, the character “/” indicates that associated objects are in an “or” relationship. For example, A/B may represent A or B. The term “and/or” in this application merely describes an association relationship between associated objects and indicates that three relationships may exist. For example, A and/or B may represent three cases: Only A exists, both A and B exist, or only B exists, where A and B may be singular or plural.

In addition, in the descriptions of this application, “a plurality of” means two or more than two unless otherwise specified. “At least one of the following” or a similar expression thereof indicates any combination of these items, including a single item or any combination of a plurality of items. For example, at least one item (piece) of a, b, and (or) c may indicate a, b, c, a and b, a and c, b and c, or a, b, and c, where a, b, and c may be singular or plural.

In addition, to clearly describe the technical solutions in embodiments of this application, terms such as first and second are used in embodiments of this application to distinguish between same items or similar items that provide basically same functions or purposes. A person skilled in the art may understand that the terms such as “first” and “second” do not limit a quantity or an execution sequence, and the terms such as “first” and “second” do not indicate a definite difference.

In addition, in embodiments of this application, the word “example” or “for example” is used to represent giving an example, an illustration, or a description. Any embodiment or design scheme described as an “example” or “for example” in embodiments of this application should not be explained as being more preferred or having more advantages than another embodiment or design scheme. Exactly, use of the terms such as “example” or “for example” is intended to present a related concept in a specific manner for ease of understanding.

It may be understood that an “embodiment” used throughout this specification means that particular features, structures, or characteristics related to this embodiment are included in at least one embodiment of this application. Therefore, embodiments in the entire specification are not necessarily a same embodiment. In addition, these particular features, structures, or characteristics may be combined in one or more embodiments by using any appropriate manner. It may be understood that sequence numbers of the processes do not mean execution sequences in embodiments of this application. The execution sequences of the processes should be determined based on functions and internal logic of the processes, and should not be construed as any limitation on implementation processes of embodiments of this application.

It can be understood that in this application, both “when . . . ” and “if” mean that corresponding processing is performed in an objective situation, are not intended to limit time, do not require a determining action during implementation, and do not mean that there are other limitations.

It may be understood that in some scenarios, some optional features in embodiments of this application may be independently implemented without depending on another feature, for example, a solution on which the optional features are currently based, to resolve a corresponding technical problem and achieve corresponding effect. Alternatively, in some scenarios, the optional features may be combined with other features based on a requirement. Correspondingly, the apparatus provided in embodiments of this application may also correspondingly implement these features or functions. Details are not described herein.

In this application, unless otherwise specified, for same or similar parts in embodiments, refer to each other. In embodiments of this application and the implementations/implementation methods in embodiments, unless otherwise specified or a logical conflict occurs, terms and/or descriptions are consistent and may be mutually referenced between different embodiments and between the implementations/implementation methods in embodiments. Technical features in the different embodiments and the implementations/implementation methods in embodiments may be combined to form a new embodiment, implementation, or implementation method based on an internal logical relationship thereof. The following implementations of this application are not intended to limit the protection scope of this application.

The technical solutions provided in embodiments of this application may be applied to various communication systems. The communication system may be a 3rd generation partnership project (3GPP) communication system, for example, a 4th generation (4G) long-term evolution (LTE) system, a 5G new radio (NR) system, a 6th generation (6G) communication system, a vehicle-to-everything (V2X) system, an LTE-NR hybrid networking system, a device-to-device (D2D) system, a machine-to-machine (M2M) communication system, the internet of Things (IoT), another future communication system, or the like. Alternatively, the communication system may be a non-3GPP communication system. This is not limited.

The foregoing communication systems applicable to this application are merely examples for description, and communication systems applicable to this application are not limited thereto. This is uniformly described herein. Details are not described below again.

The terminal device in this application may be user equipment (UE), an access terminal, a terminal unit, a subscriber station, a terminal station, a mobile station, a mobile console, a remote station, a remote terminal, user terminal (TE), a mobile device, a wireless communication device, a terminal agent, a tablet computer (pad), a handheld device having a wireless communication function, a compute device, another processing device connected to a wireless modem, a vehicle-mounted device, a vehicle-mounted transceiver unit, a wearable device, or a terminal apparatus in a network using a 5th generation (5G) mobile communication technology or an evolved public land mobile network (PLMN) after 5G. The access terminal may be a cellular phone, a cordless phone, a session initiation protocol (SIP) phone, a wireless local loop (WLL) station, a personal digital assistant (PDA), a handheld device having a wireless communication function, a compute device, another processing device connected to a wireless modem, a vehicle-mounted device, an uncrewed aerial vehicle, a robot, a smart point of sale (POS) machine, customer-premises equipment (CPE), a wearable device, a virtual reality (VR) terminal device, an augmented reality (AR) terminal device, a wireless terminal in industrial control, a wireless terminal in self-driving, a wireless terminal in remote medical, a wireless terminal in a smart grid, a wireless terminal in transportation safety, a wireless terminal in a smart city, a wireless terminal in a smart home, or the like. Alternatively, the terminal device may be a terminal having a communication function in an internet of things (IoT), for example, a terminal in V2X (for example, an internet of vehicles device), a terminal in D2D communication, or a terminal in M2M communication. The terminal device may be mobile or fixed.

A form of the terminal device is not limited in embodiments of this application. An apparatus configured to implement a function of the terminal device may be the terminal device, or may be an apparatus, for example, a chip system, that can support the terminal device in implementing the function. The apparatus may be mounted in a terminal device or used together with a terminal device. In this embodiment of this application, the chip system may include a chip, or may include a chip and another discrete component.

Optionally, the access network device in this application may be a device configured to communicate with a terminal device, for example, may include an evolved NodeB (eNB, or e-NodeB) in a long term evolution (LTE) system or an LTE-advanced (LTE-A) system, for example, a conventional macro base station eNB and a micro base station eNB in a heterogeneous network scenario. Alternatively, the access network device may include a next generation NodeB (gNB) in the NR system. Alternatively, the access network device may include a transmission reception point (TRP), a home NodeB (for example, a home evolved NodeB, HNB), a baseband unit (BBU), a baseband unit pool (BBU pool), a wireless fidelity (Wi-Fi) access point (AP), or the like. Alternatively, the access network device may include a base station in a non-terrestrial network (NTN), that is, may be deployed on an airplane platform or a satellite. In the NTN, the access network device may be used as a layer 1 (L1) relay, may be used as a base station, or may be used as an integrated access and backhaul (IAB) node. Alternatively, the access network device may be a device in an IoT that implements functions of a base station, for example, a device in uncrewed aerial vehicle communication, V2X, D2D, or machine-to-machine (M2M) that implements the functions of the base station.

In some possible scenarios, the access network device may alternatively be a module or unit that can implement a part of functions of a base station. For example, the access network device may be a central unit (CU), a distributed unit (DU), a CU-control plane (CP), a CU-user plane (UP), or a radio unit (RU). The CU and the DU may be separately arranged, or may be included in a same network element, for example, a baseband unit (BBU). The RU may be included in a radio frequency device or a radio frequency unit, for example, included in a remote radio unit (RRU), an active antenna unit (AAU), or a remote radio head (RRH).

In different systems, the CU (or the CU-CP and the CU-UP), the DU, or the RU may also have different names, but a person skilled in the art may understand meanings thereof. For example, the access network device may be an access network device or a module of the access network device in an open radio access network (open RAN, ORAN) system. In the ORAN system, the CU may also be referred to as an open (O)-CU, the DU may also be referred to as an O-DU, the CU-CP may also be referred to as an O-CU-CP, the CU-UP may also be referred to as an O-CU-UP, and the RU may also be referred to as an O-RU. Any one of the CU (or a CU-CP and a CU-UP), the DU, and the RU in this application may be implemented by using a software module, a hardware module, or a combination of a software module and a hardware module.

Optionally, the base station in embodiments of this application may include various forms of base stations, for example, a macro base station, a micro base station (or referred to as a small cell), a relay station, an access point, a home base station, a TRP, a transmitting point (TP), or a mobile switching center. This is not specifically limited in embodiments of this application.

In embodiments of this application, a form of the access network device is not limited. An apparatus configured to implement a function of the access network device may be an access network device, or may be an apparatus, for example, a chip system, that can support the access network device in implementing the function. The apparatus may be mounted in the access network device or used together with the access network device.

In a related technology, in a session-based network, point-to-point transmission is usually performed on data in the network based on a user plane session. The user plane session usually performs only data transmission based on a destination address, and cannot process data. For example, in a 5G network, a user plane session is a protocol data unit (PDU) session, and two ends of the PDU session are respectively connected to a terminal device and a network device, to implement point-to-point data transmission between the terminal device and the network device. However, based on the PDU session, only simple forwarding operations can be performed on data, and more complex data services cannot be performed on the data.

With the development of a communication network scale, technologies, and applications, an increasing amount of data is generated in a communication network, and a value of the data is also increasing. Data needs to be collected, stored, transmitted, processed, analyzed, exchanged, and shared in a network. In addition, data transmission is not limited to point-to-point transmission between two devices, but needs to be transmitted between any nodes in any topology. A current user plane session-based network cannot meet a requirement for data transmission and processing. Therefore, currently, a data-centric network architecture, for example, a 6G data plane network architecture, is proposed to meet the requirement for data transmission and processing.

In an example, a difference between a 5G user plane and a 6G data plane is shown in Table 1.

TABLE 1

| | 5G user plane | 6G data plane |
|---|---|---|
| Function | A PDU session provides an | A distributed data pipeline includes |
| | end-to-end user-plane | functions such as data acquisition, pre- |
| | connection between a terminal | processing, forwarding, storage, and |
| | device and a network | analytics |
| Start point and | Terminal device and user plane | Any network element and terminal device |
| end point | function (UPF) | |
| Data | A forwarding device forwards | The forwarding device needs to implement |
| forwarding | only a data packet | on-path computing: In a data pipeline, data |
| | | is converted and optimized when being |
| | | forwarded, to reach a state in which the |
| | | data can be analyzed and applied |
| Forwarding | A data packet is forwarded | A data packet is forwarded based on a data |
| rule | based on a destination address | service and a data pipeline identifier |
| Topology | Point-to-point connection | Any topology |
| structure | | |

In addition, when data forwarding is performed based on the 5G user plane session, information in a packet header that carries routing information in the data packet remains unchanged, data payload of the packet remains unchanged, and a path in a data forwarding process is a point-to-point path. When data forwarding is performed based on a 6G data plane, information in a packet header that carries routing information in the data packet remains unchanged, data payload of the packet changes based on a data on-path processing process, and forwarding may be performed by using a flexible network topology in a data forwarding process.

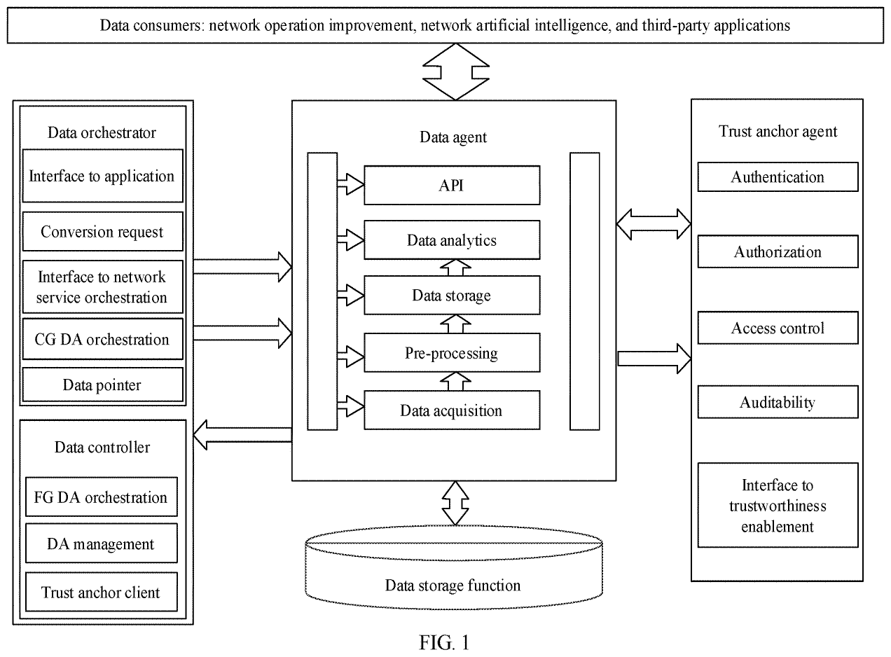

FIG. 1 is a diagram of a system architecture of a 6G data plane according to an embodiment of this application. As shown in FIG. 1, the 6G data plane includes a data orchestrator (DO), a data controller (DC), a data agent (DA), a trust anchor agent (TAA), and a data storage function (DSF).

Both the DO and the DC are used to orchestrate data pipelines for user data transmission in a network. The DO is responsible for orchestration of coarse-grained, non-real-time data services and typically incorporates the following functions: application interface (Interface to application), request translation (Req.Translation), network service orchestration interface (Interface to Network Service Orchestration), coarse-grained (CG) DA orchestration (CG DA Orchestration), and data pointer (DPTR). The DO performs data service orchestration, including data pipeline orchestration and establishment and DA orchestration, based on cross-domain service capabilities of the DA and data service tasks. The DO may further perform data service orchestration with other network services. For example, when providing data services for a compute task, the DO orchestrates data while a computational power network service orchestrates computational power. The DO has a built-in data protection technology repository (DPTR). Based on the technologies in the DPTR, the DO can provide data security and privacy protection and empower the DA with data protection technology (DPT) as required. The DPTR includes but is not limited to at least one of the following technologies: differential privacy, homomorphic encryption, secure multi-party computation, or zero-knowledge proof.

The DC is responsible for orchestration of fine-grained, real-time data services and typically incorporates the following functions: fine-grained orchestration (FG) DA orchestration (FG DA Orchestration), DA management, and a trust anchor client (TAC). The DC orchestrates and establishes data pipelines in a local domain based on DA capabilities and data service requests. The DC may further receive capability reports of the DA, register and deregister the DA capabilities accordingly, and monitor the DA in real time by detecting its heartbeats. In addition, by having a built-in trust anchor client, the DC can initiate authentication, authorization, access control, and other security requests to the TAA, and apply for source tracing and auditing services for data access. The DC can be deployed on the access network side and the core network side.

The DA is used to communicate with data consumers, which include but are not limited to network operational improvement, network artificial intelligence (network AI), and third-party applications (3rd party applications). The DA exposes an application programming interface (API) to communicate with other devices and invoke their functions. The DA typically supports data service capabilities, such as data acquisition, data pre-processing (Pre-processing), data storage, data privacy protection, data analytics, and data sharing. The DA can serve as a data requester (consumer) or a data processor (producer or provider). As a data processor, the DA can execute, based on its data service capabilities, data services such as data acquisition, data pre-processing, data storage, data analytics, and data sharing within the data pipeline orchestrated by the DO. As a data requester, the DA can report a required data service task to the DO, which then performs data service orchestration based on the data service task. The DA may be deployed on a network function (NF), a radio access network (radio access network, RAN), a transmission network (TN) node, a terminal device, or operation administration and maintenance (OAM) in a network, or the DA may be deployed independently. Data acquisition involves collecting data from a data source, either via subscription/notification or request/response. The DA can send a data acquisition request to the data source to obtain data. The data acquisition request indicates a trigger manner, a trigger condition, a reporting period, a data amount, and the like for the data source to report data. The data collected by the DA can be user data, network data, artificial intelligence (AI) data, and IoT data. The data can be real-time or non-real-time data, and the data is collected by using streaming or batch methods. Data pre-processing involves pre-processing collected raw data to improve data quality. The collected raw data usually includes dirty data such as data loss, data noise, data redundancy, and data set imbalance. The DA can pre-process data through cleaning, filling, smoothing, merging, standardizing, and consistency checking to improve the data quality. Data storage means that the DA stores data. Generally, the DA locally stores a small amount of data, short-term data, or privacy-sensitive data. Data privacy protection uses techniques such as k-anonymity, l-diversity, t-closeness, and differential privacy, to de-identify data, preventing attackers from extracting sensitive information from desensitized data. These techniques can be pre-installed in the DA or pushed by the DO on demand. Data analytics is used to analyze collected data by invoking DA data services such as data acquisition, data pre-processing, and data storage through the API. Data analytics technologies include but are not limited to AI/machine learning (ML), Hive, and Spark. The data analytics technologies can be pre-installed or pushed by a network service. The data analytics function can be coupled with the DA, embedded within the DA, or set separately from the DA.

The TAA serves as an agent of a 6G trust plane on a data plane, and is used to ensure the trustworthiness of 6G data. The TAA includes trust functions such as authentication, authorization, access control, auditability (Auditability), an interface to trustworthiness enablement (such as a block chain (BC)), and traceability, and provides an interface for supporting trust technologies such as the block chain. The TAA can protect confidentiality, integrity, and reliability of all data. The TAA may be used to store immutable data, for example, public keys of terminal devices or network devices, small-sized transactions, indexes, or important data that must not be tampered with.

The DSF is a storage extension component of the DA for large-scale data storage or long-term data storage. It is used to store AI model data, key performance index (KPI) data, log data, and alarm data. The DSF supports unified storage of structured, unstructured, and semi-structured data, as well as dynamic classification and multi-level storage of various files. Data storage technologies used by the DSF include but are not limited to at least one of the following: centralized databases and distributed databases, for example, distributed hash tables (DHTs) or the inter planetary file system (IPFS). Data storage encryption technologies used by the DSF include but are not limited to at least one of the following: database external encryption, transparent data encryption (TDE), transparent file encryption (TFE), user-defined function (UDF) encryption, and full disk encryption (FDE).

In the 6G network, data is managed and processed through a data pipeline. Data is transmitted in the data pipeline, and data services such as data acquisition, transmission, storage, and processing are completed when the data passes through a node (DA) of the data pipeline. In the 6G network, the DA may be deployed in network elements such as a terminal device, an access network device, and a core network device. Therefore, all network elements in the 6G network may participate in the data service.

Native sensing and intelligence capabilities are added to the 6G network. Native sensing refers to sensing a network status, a surrounding environment, and a user/device behavior by using a sensing device, and generating sensing data. Intelligence refers to modeling analysis and automatic decision-making using technologies such as AI and digital twins to improve network operation efficiency, improve system performance, and provide data services for intelligent applications. A terminal device, an edge device, an access network device, and a core network device in the 6G network based on functions such as native sensing and intelligence generate massive data. The terminal device, the edge device, the access network device, and the core network device in the 6G network may be a data producer and provider, and may alternatively be a data consumer. The 6G user plane is used to provide data services for the data, and meet different processing requirements of the data. Based on analysis of various application scenarios and requirements of the 6G network, a data service type that can be provided by the 6G data plane is shown in the following Table 2.

TABLE 2

| Data service | Service description |
|---|---|
| Raw data | Input collected raw data into applications (such as AI). |
| Data pre- | Pre-processing services such as data cleaning, filtering, |
| processing | aggregation, and fusion |
| Data storage | Provide centralized or distributed storage services on a |
| | DA, a DSF, or a digital linear tape (DLT) |
| Data privacy | Provide end-to-end data privacy and security protection |
| and security | technologies |
| protection | |
| Data sharing/ | Trust data sharing and transaction |
| transaction | |
| Data source | Technically meet data protection requirements, support |
| tracing | source tracing and audit services, and provide distribution |
| | services such as public keys and decentralized identities |
| | (DID). |
| Data | Perform analysis and mining based on AI, ML, and big |
| analytics | data to provide intelligent services |
| Data | Wireless network feature data set |
| dictionary | 6G network knowledge graph |

The foregoing describes the 6G network and the data plane of the 6G network in the related technology.

In a 6G network, because the DA may be deployed in the terminal device, the terminal device may also participate in the data service as the data producer, the data consumer, or the data provider. The terminal device may also participate in the data service by enabling a data service capability. However, enabling the data service capability on the terminal device needs to be performed by using subscription data. This requires a user to carry the terminal device to an operator's business hall to perform an operation or perform an operation in an operator app. Consequently, the operation performed when a data service function is enabled on the terminal device is complex.

To resolve the foregoing technical problem, an embodiment of this application provides a communication method. When detecting that a data service function is enabled, a terminal device obtains address information of a data controller, and registers a data service capability of the terminal device with the data controller. In this way, when a user needs to enable the data service function, the user can enable the data service function only by performing an operation on the terminal device, and does not need to perform an operation in an operator's business hall or perform an operation in an operator app. This reduces complexity of the operation performed when the data service function is enabled on the terminal device.

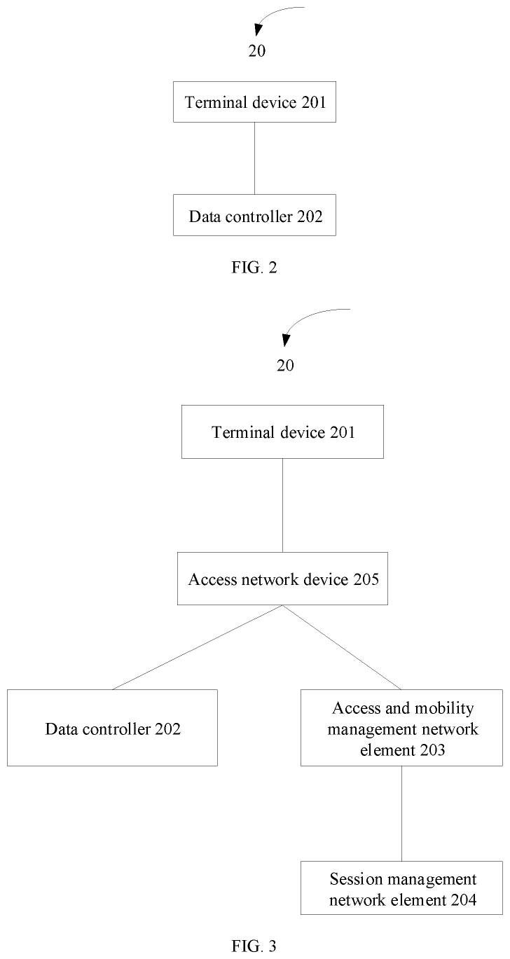

The communication method provided in this embodiment of this application may be applied to a communication system 20 shown in FIG. 2. As shown in FIG. 2, the communication system 20 includes a terminal device 201 and a data controller 202.

A data service capability can be enabled/disabled in the terminal device 201. The terminal device may enable the data service capability based on a detected operation of enabling the data service capability. Alternatively, the terminal device may disable the data service capability based on a detected operation of disabling the data service capability. The data controller 202 is configured to manage the data service capability of the terminal device 201.

In a possible implementation, when detecting that the data service function is enabled, the terminal device 201 obtains address information of the data controller 202 and registers the data service capability of the terminal device 201 with the data controller 202. After registering the data service capability of the terminal device 201, the data controller 202 may orchestrate the terminal device 201 based on the data service capability of the terminal device 201, for example, orchestrate a processing role of the terminal device 201 in processing a data service.

When detecting that the data service function is disabled, the terminal device 201 deregisters the data service capability of the terminal device 201 from the data controller 202. After deregistering the data service capability of the terminal device 201, the data controller 202 does not perform data service orchestration on the terminal device 201.

With reference to FIG. 2, as shown in FIG. 3, the communication system provided in this embodiment of this application further includes an access and mobility management network element 203, a session management network element 204, and an access network device 205.

The terminal device 201 may obtain the address information of the data controller 202 from the access and mobility management network element 203 by interacting with the access and mobility management network element 203. The access and mobility management network element 203 may obtain the address information of the data controller 202 from the session management network element 204 by interacting with the session management network element 204. The terminal device 201 may communicate with the access and mobility management network element 203 or the data controller 202 through the access network device 205.

In a possible implementation, when the terminal device 201 obtains the address information of the data controller 202, the terminal device 201 first initiates registration to the access and mobility management network element 203 to indicate that the terminal device 201 supports the data service capability. The access and mobility management network element 203 indicates, to the terminal device, that a network side supports the data service capability. Further, the terminal device 201 initiates a PDU session establishment procedure to the access and mobility management network element 203, and indicates, in the procedure, to obtain the address information of the data controller 202. The access and mobility management network element 203 and the session management network element 204 create a PDU session context, and obtain the address information of the data controller 202 from the session management network element 204. Then, the access and mobility management network element 203 sends a PDU session establishment complete message to the terminal device through the access network device. The PDU session establishment complete message carries the address information of the data controller 202.

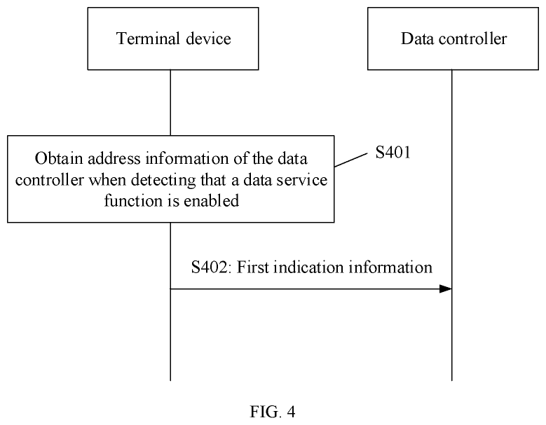

With reference to the communication system shown in FIG. 2 or FIG. 3, FIG. 4 shows a communication method according to an embodiment of this application. The communication method is described by using an example in which a terminal device enables a data service capability and the terminal device interacts with a data controller to register the data service capability. Certainly, an execution body of an action of the terminal device in the method may alternatively be an apparatus or a module in the terminal device, for example, a chip, a processor, or a processing unit in the terminal device. An execution body of an action of the data controller in the method may alternatively be an apparatus or a module in the data controller, for example, a chip, a processor, or a processing unit in the data controller. This is not specifically limited in this embodiment of this application. In this embodiment of this application, processing performed by a single execution body (for example, the terminal device or the data controller) may alternatively be performed by a plurality of execution bodies, and these execution bodies may be logically and/or physically separated. For example, as shown in FIG. 4, the method includes the following steps.

S401: When detecting that a data service function is enabled, the terminal device obtains address information of the data controller.

The data controller is configured to manage the data service function of the terminal device. Optionally, the address information of the data controller may be an internet protocol (IP) address of the data controller.

In a possible implementation, the terminal device may display a data service capability on a display interface. In this way, when a user needs to enable the data service function, the user may directly perform an operation of enabling the data service capability on the display interface of the terminal, and the terminal device detects the operation of enabling the data service capability by the user and enables a data service capability. Then, the terminal device obtains the address information of the data controller.

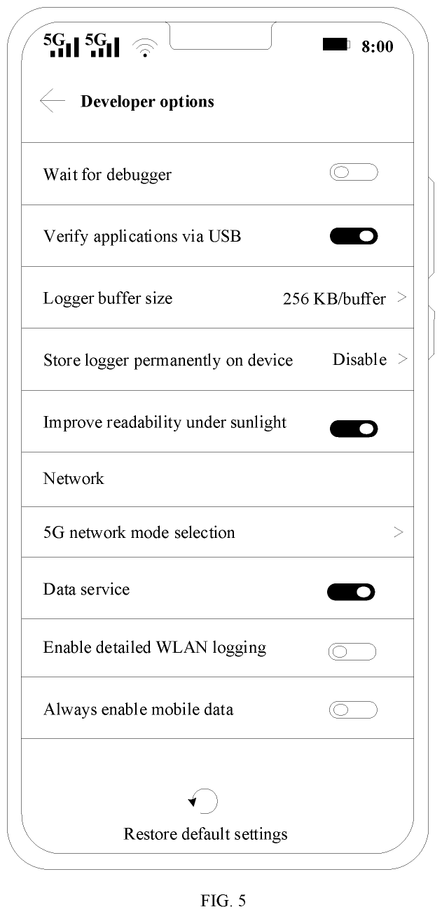

In an example, the display interface on which the terminal device enables/disables the data service capability is shown in FIG. 5.

S402: The terminal device sends first indication information to the data controller based on the address information of the data controller. Correspondingly, the data controller receives the first indication information from the terminal device.

The first indication information indicates that the terminal device supports the data service capability.

In an example, when the address information of the data controller is the IP address, a destination IP address of the first indication information is the IP address of the data controller.

In a possible implementation, after receiving the first indication information from the terminal device, the data controller registers the data service capability of the terminal device with the data controller. When a data service task needs to be orchestrated, the data controller determines, based on a requirement of a data service, whether to orchestrate the terminal device to provide the data service capability for the data service task. When determining to orchestrate the terminal device to provide the data service capability for the data service task, the data controller orchestrates a role and a processing task of the terminal device. When the data service task is transferred to the terminal device through a data pipeline, the terminal device processes the data service task based on orchestration of the data controller. Alternatively, the terminal device is used as a data source device, and after collecting data, the terminal device transmits the collected data to an access network device or another node in a network through a pipeline orchestrated by the data controller.

In this embodiment of this application, when detecting that the data service function is enabled, the terminal device obtains the address information of the data controller and registers the data service capability of the terminal device with the data controller. In this way, when the user needs to enable the data service function, the user can enable the data service function only by performing an operation on the terminal device, and does not need to perform an operation in an operator's business hall or perform an operation in an operator app. This reduces complexity of the operation performed when the data service function is enabled on the terminal device.

In a possible implementation, the terminal device may obtain the address information of the data controller in the following Manner 1, Manner 2, or Manner 3, which are respectively: Manner 1: The terminal device receives second indication information from an access and mobility management network element, where the second indication information indicates the address information of the data controller; Manner 2: The terminal device reads pre-configured address information of the data controller from the terminal device; and Manner 3: The terminal device reads pre-configured address information of the data controller from an identity card of the terminal device.

In Manner 2 and Manner 3, the address information of the data controller is pre-configured in the terminal device or the identity card (such as a subscriber identity module (SIM) card) of the terminal device. Based on Manner 2 and Manner 3, the terminal device may directly obtain the address information of the data controller. Details are not described in this application.

In Manner 1, the terminal device needs to interact with the network element to obtain the address information of the data controller. The following describes an example of a process in which the terminal device obtains the address information of the data controller in Manner 1.

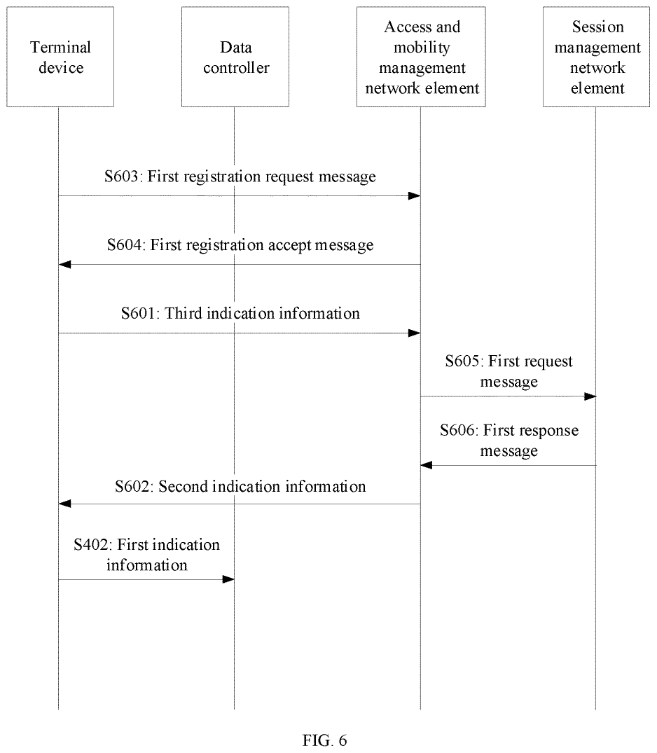

With reference to FIG. 4, as shown in FIG. 6, in Manner 1, a process in which the terminal device obtains the address information of the data controller may be specifically implemented by using the following steps.

S601: A terminal device sends third indication information to an access and mobility management network element. Correspondingly, the access and mobility management network element receives the third indication information from the terminal device.

The third indication information indicates to obtain address information of a data controller.

S602: The access and mobility management network element sends second indication information to the terminal device. Correspondingly, the terminal device receives the second indication information from the access and mobility management network element.

In this way, based on the foregoing S601 and S602, the terminal device may obtain the address information of the data controller from the access and mobility management network element. Then, the terminal device may further perform the process in S402, to register a data service capability of the terminal device with the data controller.

In a possible implementation, the third indication information is carried in a PDU session establishment request message, and the second indication information is carried in a PDU session establishment response message.

In other words, the terminal device sends, to the access and mobility management network element, the PDU session establishment request message that carries the third indication information. After receiving the PDU session establishment request message that carries the third indication information, an access network device performs a subsequent PDU session establishment procedure, includes the second indication information in the PDU session establishment response message, and sends the PDU session establishment response message to the terminal device. The terminal device determines the address information of the data controller based on the second indication information carried in the PDU session establishment response message.

Optionally, after receiving the third indication information from the terminal device, the access and mobility management network element sends a PDU session context creation request to a session management network element. The PDU session context creation request carries information for requesting the address information of the data controller. The session management network element sends the address information of the data controller to the access and mobility management network element based on the PDU session context creation request. Further, the access and mobility management network element generates the second indication information based on the address information of the data controller, and sends the second indication information to the terminal device.

In a possible implementation, as shown in FIG. 6, before the foregoing S601, the terminal device may pre-determine whether both the terminal device and a network side support a data service capability, and perform the foregoing S601 and S602 when both the terminal device and the network side support the data service capability. A process in which the terminal device determines that both the terminal device and the network side support the data service capability includes the following S603 and S604, which are described in detail below.

S603: The terminal device sends a first registration request message to the access and mobility management network element. Correspondingly, the access and mobility management network element sends the first registration request message to the terminal device.

The first registration request message indicates that the terminal device supports the data service capability.

S604: The access and mobility management network element sends a first registration accept message to the terminal device. Correspondingly, the terminal device receives the first registration accept message from the access and mobility management network element.

The first registration accept message indicates that the network side supports the data service capability.

In a possible implementation, after detecting an operation of enabling a data service capability by a user and enabling the data service capability, the terminal device indicates, to the access and mobility management network element on the network side, that the terminal device supports the data service capability (or the terminal device has enabled the data service capability). The access and mobility management network element indicates, to the terminal device, that the network side also supports the data service capability. In this case, the terminal device may execute a data service task based on the data service capability of the terminal device and the data service capability of the network side. Then, the terminal device may further obtain the address information of the data controller, to register the data service capability of the terminal device with the data controller.

It should be noted that the network side in this embodiment of this application includes the access and mobility management network element and another network element. This is not limited in this application.

In a possible implementation, as shown in FIG. 6, before the foregoing S602, the access and mobility management network element may obtain the address information of the data controller from a session management network element, and generate the second indication information based on the obtained address information of the data controller. A specific process is shown in the following S605 and S606.

S605: The access and mobility management network element sends a first request message to the session management network element. Correspondingly, the session management network element receives the first request message from the access and mobility management network element.

The first request message is used to request to obtain the address information of the data controller.

S606: The session management network element sends a first response message to the access and mobility management network element. Correspondingly, the access and mobility management network element receives the first response message from the session management network element.

The first response message indicates the address information of the data controller.

In a possible implementation, the first request message is carried in a PDU session context creation request message, and the first response message is carried in a message in an N1N2 message transfer procedure. Based on this, the access and mobility management network element may obtain the address information of the data controller in the PDU session context creation procedure and the N1N2 message transfer procedure with the session management network element.

In a possible implementation, the access network device may alternatively report, to the access and mobility management network element, whether the access network device supports the data service capability. Specifically, the access network device sends an access network configuration update message to the access and mobility management network element. Then, the session management network element sends an access network configuration acknowledgment message to the access network device.

The access network configuration update message indicates that the access network device supports the data service capability. In an example, the access network configuration update message is ran configuration update. The access network configuration acknowledgment message is ran configuration acknowledge.

Optionally, ran configuration update includes a data service capability field, and the data service capability field indicates that the access network device supports the data service capability.

In an example, the newly added data service capability field in ran configuration update includes:

```
  { ID id-SupportedDataServiceRITICALITY ignore TYPE
SupportedDataService
  ...
  }
  SupportedDataService ::= ENUMERATED {true, false}
```

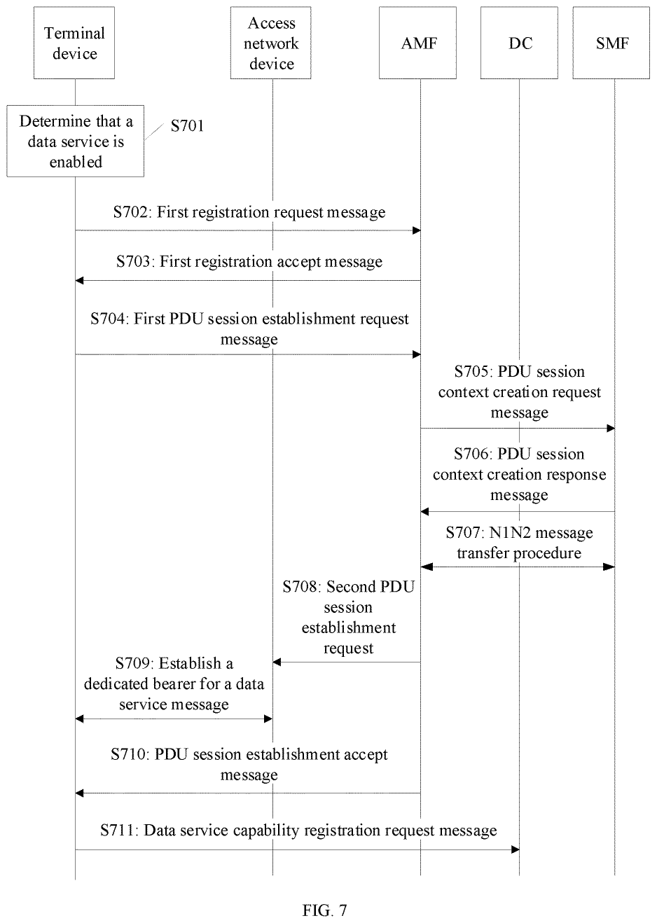

With reference to the embodiment shown in FIG. 6, the following describes the communication method provided in embodiments of this application in detail by using an example in which the data controller is a DC, the access and mobility management network element is an access and mobility management function (AMF), and the session management network element is a session management function (SMF). As shown in FIG. 7, when the terminal device enables a data service, the communication method provided in this embodiment of this application includes the following steps.

S701: A terminal device determines that the data service is enabled.

In a possible implementation, a user performs an operation of enabling the data service on a display interface shown in FIG. 5. After detecting this operation, the terminal device determines that the data service is enabled. In this case, the terminal device supports a data service capability and has enabled the data service capability.

S702: The terminal device sends a first registration request message to an AMF. Correspondingly, the AMF receives the first registration request message from the terminal device.

The first registration request message indicates that the terminal device supports the data service capability.

In an example, the first registration request message is a register request. Optionally, the register request carries an indication flag bit for the data service capability of the terminal device. The indication flag bit indicates whether the terminal device supports the data service capability.

For example, a value of 1 for the indication flag bit indicates that the terminal device supports the data service capability (or the terminal device has enabled the data service capability); a value of 0 indicates that the terminal device does not support the data service capability (or the terminal device has disabled the data service capability). Conversely, a value of 0 for the indication flag bit indicates that the terminal device supports the data service capability (or the terminal device has enabled the data service capability); a value of 1 indicates that the terminal device does not support the data service capability (or the terminal device has disabled the data service capability). This embodiment of this application uses an example in which the indication flag bit for the data service capability is 1 bit for description. The indication flag bit may also be a plurality of bits. This is not specifically limited in this embodiment of this application.

Optionally, in this embodiment of this application, the indication flag bit for the data service capability of the terminal device may be added to a bit position (for example, the eighth bit) of the tenth octet in the tenth field (or an information element (IE)), namely, 5GMM capability (5G mobility management capability), in the register request. The value of the indication flag bit supports the data service capability.

In an example, as shown in the following Table 3, in the 5GMM capability field, a first byte is used to represent an information element identifier (information element identity, IEI) of the 5GMM capability (5GMM capability IEI), and a second byte is used to represent the length of contents of the 5GMM capability field (length of 5GMM capability contents).

TABLE 3

| 8 | 7 | 6 | 5 | 4 | 3 | 2 | 1 | |
|---|---|---|---|---|---|---|---|---|
| 5GMM capability IEI | | | | | | | | Octet 1 |
| Length of 5GMM capability contents | | | | | | | | Octet 2 |
| ** | ** | ** | ** | ** | ** | ** | ** | Octet 3 |
| ** | ** | ** | ** | ** | ** | ** | ** | Octet 4* |
| ** | ** | ** | ** | ** | ** | ** | ** | Octet 5* |
| ** | ** | ** | ** | ** | ** | ** | ** | Octet 6* |
| ** | ** | ** | ** | ** | ** | ** | ** | Octet 7* |
| ** | ** | ** | ** | ** | ** | ** | ** | Octet 8* |
| ** | ** | ** | ** | ** | ** | ** | ** | Octet 9* |
| 0 spare | Data | ** | ** | ** | ** | ** | ** | Octet 10* |
| | service | | | | | | | |
| 0 | 0 | 0 | 0 | 0 | 0 | 0 | 0 | Octet 11 |
| | | | | | | | | to 15* |

In Table 3 above, “**” indicates that the contents represented in the table may be referred to existing technologies. Details are not described in this application.

S703: The AMF sends a first registration accept message to the terminal device. Correspondingly, the terminal device receives the first registration accept message from the AMF.

The first registration accept message indicates that the AMF supports the data service capability.

In an example, the first registration accept message is register accept. Optionally, register accept carries an indication bit for the data service capability of the network side. The indication bit for the data service capability of the network side indicates whether the network side supports the data service capability.

For example, when the value of the indication bit for the data service capability of the network side is 1, it indicates that the network side supports the data service capability; and when the value of the indication bit for the data service capability of the network side is 0, it indicates that the network side does not support the data service capability. Alternatively, for example, when the value of the indication bit for the data service capability of the network side is 0, it indicates that the network side supports the data service capability; and when the value of the indication bit for the data service capability of the network side is 1, it indicates that the network side does not support the data service capability. Certainly, in this embodiment of this application, an example in which the indication flag bit for the data service capability is 1 bit is used for description. Alternatively, the indication flag bit for the data service capability may be a plurality of bits. This is not specifically limited in this embodiment of this application.

Optionally, in this embodiment of this application, a flag bit indicating the data service capability of the network side may be added to a bit (for example, a second bit) of a sixth byte in a sixth field (or information element), namely, 5GS network feature support (5G system network function support), in register accept, and a value of the flag bit indicates whether the network side supports the data service capability.

In an example, as shown in the following Table 4, a first byte in the 5GS network feature support field is used to represent an information element identifier (namely, 5GS network feature support IEI) of 5GS network feature support. A second byte indicates a length of contents of the 5GS network feature support field (namely, a length of 5GS network feature support contents).

TABLE 4

| 8 | 7 | 6 | 5 | 4 | 3 | 2 | 1 | |
|---|---|---|---|---|---|---|---|---|
| 5GS network feature support IEI | | | | | | | | Octet 1 |
| Length of 5GS network feature support contents | | | | | | | | Octet 2 |
| ** | ** | ** | ** | ** | ** | ** | ** | Octet 3 |
| ** | ** | ** | ** | ** | ** | ** | ** | Octet 4* |
| ** | ** | ** | ** | ** | ** | ** | ** | Octet 5* |
| 0 spare | ** | ** | ** | ** | ** | Data | ** | Octet 6* |
| | | | | | | service | | |

In Table 4 above, “**” indicates that the contents represented in the table can be referred to a conventional technology. Details are not described in this application.

S704: The terminal device sends a first PDU session establishment request message to the AMF. Correspondingly, the AMF receives the first PDU session establishment request message from the terminal device.

In a possible implementation, the first PDU session establishment request message carries an extended protocol configuration option field, and the extended protocol configuration option field indicates to obtain address information of a DC.

In an example, the first PDU session establishment request message is PDU Session Establishment Request. The extended protocol configuration option field carried in the first PDU session establishment request message is Extended protocol configuration options.

For example, fields 001BH (DC IPv6 Address Request) and 001CH (DC IPv4 Address Request) in the Extended protocol configuration options field of PDU Session Establishment Request in S704 specifically indicate to obtain the address information of the DC.

S705: The AMF sends a PDU session context creation request message to an SMF. Correspondingly, the SMF receives the PDU session context creation request from the AMF.

In a possible implementation, the PDU session context creation request message carries an extended protocol configuration option field, and the extended protocol configuration option field indicates to obtain the address information of the DC.

In an example, the PDU session context creation request message is Nsmf_PDUSession_CreateSMContext Request. The extended protocol configuration option field carried in the PDU session context creation request message is Extended protocol configuration options.

S706: The SMF sends a PDU session context creation response message to the AMF. Correspondingly, the AMF receives the PDU session context creation response message from the SMF.

In an example, the PDU session context creation response message is Nsmf_PDUSession_CreateSMContext Response.

S707: The SMF and the AMF perform an N1N2 message transfer procedure.

In a possible implementation, in the N1N2 message transfer procedure performed by the SMF and the AMF, the SMF sends the extended protocol configuration option field to the AMF through the N1N2 message transfer procedure.

In an example, the N1N2 message transfer procedure is an Namf_Communication_N1N2MessageTransfer procedure. The extended protocol configuration option field sent by the SMF to the AMF through the N1N2 message transfer procedure is Extended protocol configuration options.

In a possible implementation, the Extended protocol configuration options field in the Namf_Communication_N1N2MessageTransfer procedure carries the address information of the DC. Further, the AMF may obtain the address information of the DC from the SMF.

It should be noted that extended protocol configuration option fields in the foregoing different messages may be the same or may be different. This is not limited in this embodiment of this application.

S708: The AMF sends a second PDU session establishment request to an access network device. Correspondingly, the access network device receives the second PDU session establishment request from the AMF.

In an example, the second PDU session establishment request message is PDU Session establishment Request.

S709: The access network device interacts with the terminal device to establish a dedicated bearer for a data service message.

S710: The AMF sends a PDU session establishment accept message to the terminal device.

In a possible implementation, the PDU session establishment accept message carries the extended protocol configuration option field and the address information of the DC.

In an example, the PDU session establishment accept message is PDU Session Establishment Accept. The extended protocol configuration option field carried in the PDU session establishment accept message is Extended protocol configuration options. The address information of the DC is an IP address of the DC. The IP address of the DC may be carried in Extended protocol configuration options.

For example, fields 000AH (DC IPv6 Address) and 000BH (DC IPv4 Address) in the Extended protocol configuration options field in PDU Session Establishment Accept in S710 are used to carry the address information of the DC.

S711: The terminal device sends a data service capability registration request message to the DC.

The foregoing describes in detail the communication method provided in embodiments of this application by using an example in which the terminal device interacts with the data controller to register the data service capability.

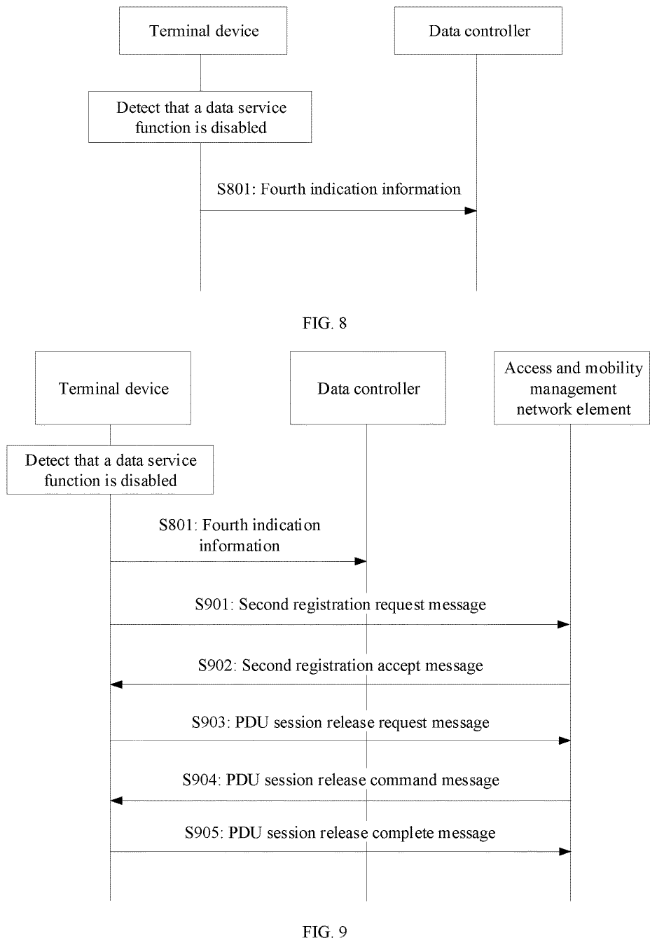

With reference to the communication system shown in FIG. 2 or FIG. 3, FIG. 8 shows a communication method according to an embodiment of this application. The communication method is described by using an example in which a terminal device disables a data service capability and the terminal device interacts with a data controller to deregister the data service capability. Certainly, an execution body of an action of the terminal device in the method may alternatively be an apparatus or a module in the terminal device, for example, a chip, a processor, or a processing unit in the terminal device. An execution body of an action of the data controller in the method may alternatively be an apparatus or a module in the data controller, for example, a chip, a processor, or a processing unit in the data controller. This is not specifically limited in this embodiment of this application. In this embodiment of this application, processing performed by a single execution body (for example, the terminal device or the data controller) may alternatively be performed by a plurality of execution bodies, and these execution bodies may be logically and/or physically separated. For example, as shown in FIG. 8, the method includes the following steps.

S801: When detecting that a data service function is disabled, a terminal device sends fourth indication information to a data controller. Correspondingly, the data controller receives the fourth indication information from the terminal device.

The fourth indication information is used to deregister a data service capability of the terminal device from the data controller.

In a possible implementation, with reference to the interface for enabling/disabling the data service capability shown in FIG. 5, when a user needs to disable the data service function, the user may directly perform an operation of disabling the data service capability on a display interface of the terminal, and the terminal device detects the operation of disabling the data service capability by the user and disables the data service capability. Then, the terminal device deregisters the data service capability from the data controller.

In this embodiment of this application, when detecting that the data service function is disabled, the terminal device deregisters the data service capability of the terminal device from the data controller. In this way, when the user needs to disable the data service function, the user can disable the data service function only by performing an operation on the terminal device, and does not need to perform an operation in an operator's business hall or perform an operation in an operator app. This reduces complexity of the operation performed when the data service function is disabled on the terminal device. In addition, in this embodiment of this application, the user may enable or disable the data service function on the terminal device, so that flexibility of using the data service capability by the terminal device can be greatly improved.

In a possible implementation, when the terminal device detects that the data service function is disabled, in addition to deregistering the data service capability from the data controller, the terminal device may further update, to an access and mobility management network element, that the terminal device does not support the data service capability, and request to release a PDU session establish for the data service capability. With reference to FIG. 8, as shown in FIG. 9, a process in which the terminal device updates, to the access and mobility management network element, that the terminal device does not support the data service capability includes the following steps.

S901: The terminal device sends a second registration request message to the access and mobility management network element. Correspondingly, the access and mobility management network element receives the second registration request message from the terminal device.

The second registration request message indicates that the terminal device does not support the data service capability.

S902: The access and mobility management network element sends a second registration accept message to the terminal device. Correspondingly, the terminal device receives the second registration accept message from the access and mobility management network element.

Based on this, after detecting that the data service function is disabled, the terminal device can indicate to the access and mobility management network element that the terminal device does not support the data service capability, thereby ensuring consistency between the terminal side and the network side regarding whether the terminal device supports the data service capability.

As shown in FIG. 9, a process in which the terminal device requests to release the PDU session established for the data service capability includes the following steps.

S903: The terminal device sends a PDU session release request message to the access and mobility management network element. Correspondingly, the access and mobility management network element receives the PDU session release request message from the terminal device.

S904: The access and mobility management network element sends a PDU session release command message to the terminal device. Correspondingly, the terminal device receives the PDU session release command message from the access and mobility management network element.

S905: The terminal device sends a PDU session release complete message to the access and mobility management network element. Correspondingly, the access and mobility management network element receives the PDU session release complete message from the terminal device.

Optionally, for a specific implementation of a PDU session release process, refer to the conventional technology. Details are not described in this application.

Based on this, the terminal device can request to release the PDU session after detecting that the data service function is disabled, to avoid occupying a session resource in a network.

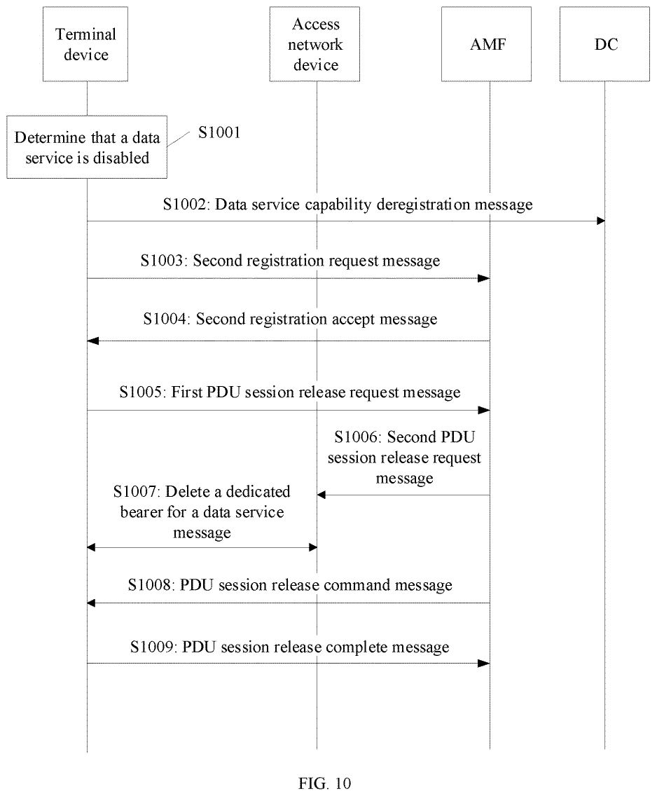

With reference to the embodiment in FIG. 9, the following describes the communication method provided in embodiments of this application in detail by using an example in which a data controller is a DC, the access and mobility management network element is an AMF, and a session management network element is an SMF. As shown in FIG. 10, when a terminal device enables a data service, the communication method provided in this embodiment of this application includes the following steps.

S1001: The terminal device determines that the data service is disabled.

In a possible implementation, a user performs an operation of disabling the data service on the display interface shown in FIG. 5. After detecting the operation of disabling the data service by the user, the terminal device determines that the data service is disabled. In this case, the terminal device does not support a data service capability, and the data service capability of the terminal device is disabled.

S1002: The terminal device sends a data service capability deregistration message to a DC. Correspondingly, the DC receives the data service capability deregistration message from the terminal device.

It may be understood that, after the DC receives the data service capability deregistration message from the terminal device, the DC deregisters the data service capability of the terminal device. In a subsequent process of orchestrating a data service task, the DC does not orchestrate the terminal device.

S1003: The terminal device sends a second registration request message to an AMF. Correspondingly, the AMF receives the second registration request message from the terminal device.

The second registration request message indicates that the terminal device does not support the data service capability.

In an example, the second registration request message is register request.

For example, with reference to S702, when a value of the indication flag bit for the data service capability of the terminal device is 1, it indicates that the terminal device supports the data service capability (or the terminal device has enabled the data service capability); and when the value of the indication flag bit for the data service capability of the terminal device is 0, it indicates that the terminal device does not support the data service capability (or the terminal device has disabled the data service capability). In this case, the terminal device may adjust the value of the flag bit indicating the data service capability of the terminal device and that is in register request to 0, to indicate that the terminal device does not support the data service capability. Alternatively, when the value of the indication flag bit for the data service capability of the terminal device is 0, it indicates that the terminal device supports the data service capability (or the terminal device has enabled the data service capability); and when the value of the indication flag bit for the data service capability of the terminal device is 1, it indicates that the terminal device does not support the data service capability (or the terminal device has disabled the data service capability). In this case, the terminal device may adjust the value of the flag bit indicating the data service capability of the terminal device and that is in register request to 1, to indicate that the terminal device does not support the data service capability.

For specific contents of the second registration request message, refer to Table 3 in S702 for understanding. Details are not described in this application.

S1004: The AMF sends a second registration accept message to the terminal device. Correspondingly, the terminal device receives the second registration accept message from the AMF.

In an example, the second registration accept message is Register Accept.

It should be noted that the second registration accept message may indicate whether the AMF supports the data service capability, or may not indicate whether the AMF supports the data service capability. This is not limited in this application.

When the second registration accept message indicates whether the network side supports the data service capability, for specific contents of the second registration accept message, refer to content in Table 4 in S703. When the second registration accept message does not indicate whether the network side supports the data service capability, for specific contents of the second registration accept message, refer to the conventional technology. Details are not described in this application.

S1005: The terminal device sends a first PDU session release request message to the AMF. Correspondingly, the AMF receives the first PDU session release request message from the terminal device.

In an example, the first PDU session release request message is PDU Session Release Request.

S1006: The AMF sends a second PDU session release request message to an access network device. Correspondingly, the access network device receives the second PDU session release request message from the AMF.

In an example, the second PDU session release request message is PDU Session Release Request.

S1007: The access network device interacts with the terminal device to delete a dedicated bearer of a data service message.

S1008: The AMF sends a PDU session release command message to the terminal device. Correspondingly, the terminal device receives the PDU session release command message from the AMF.

In an example, the PDU session release command message is PDU Session Release Command.

S1009: The terminal device sends a PDU session release complete message to the AMF. Correspondingly, the AMF receives the PDU session release complete message from the terminal device.

In an example, the PDU session release complete message is PDU Session Release Complete.

Optionally, for specific contents of S1005 to S1009, refer to a conventional technology. Details are not described in this application again.

The foregoing describes the solutions provided in embodiments of this application mainly from a perspective of interaction between network elements. Correspondingly, an embodiment of this application further provides a communication apparatus, and the communication apparatus is configured to implement the foregoing methods. The communication apparatus may be the access and mobility management network element in the foregoing method embodiments, or an apparatus including the foregoing access and mobility management network element, or a component that can be used in the access and mobility management network element. Alternatively, the communication apparatus may be the terminal device in the foregoing method embodiments, or an apparatus including the foregoing terminal device, or a component that can be used in the terminal device. It may be understood that, to implement the foregoing functions, the communication apparatus includes a hardware structure and/or a software module for performing a corresponding function. A person skilled in the art should easily be aware that, in combination with units and algorithm steps of the examples described in embodiments disclosed in this specification, this application may be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

In embodiments of this application, the communication apparatus may be divided into functional modules based on the foregoing method embodiments. For example, each functional module may be obtained through division based on each corresponding function, or two or more functions may be integrated into one processing module. The integrated module may be implemented in a form of hardware, or may be implemented in a form of software functional module. It should be understood that, in embodiments of this application, module division is an example, and is merely logical function division. In actual implementation, another division manner may be used.

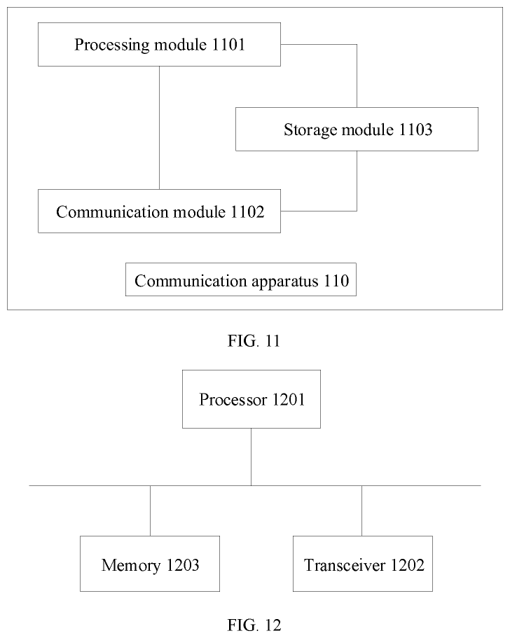

For example, FIG. 11 is a diagram of a structure of a communication apparatus 110, including a processing module 1101 and a communication module 1102, and optionally, further including a storage module 1103. The storage module 1103 is configured to store program code and data of the communication apparatus 110.

An example in which the communication apparatus 110 may be the terminal device in the foregoing method embodiments, or an apparatus including the foregoing terminal device, or a component that can be used in the terminal device is used.

A processing module 1101 is configured to: when detecting that a data service function is enabled, obtain address information of a data controller, where the data controller is configured to manage a data service function of the terminal device.

The processing module 1101 is further configured to indicate, based on the address information of the data controller, a communication module 1102 to send first indication information to the data controller, where the first indication information is used to register a data service capability of the terminal device with the data controller.

In a possible implementation, the processing module 1101 is further configured to: indicate the communication module 1102 to receive second indication information from an access and mobility management network element, where the second indication information indicates the address information of the data controller; or read pre-configured address information of the data controller from the terminal device; or read pre-configured address information of the data controller from an identity card of the terminal device.

The processing module 1101 is further configured to indicate the communication module 1102 to send third indication information to the access and mobility management network element, where the third indication information indicates to obtain the address information of the data controller.

In a possible implementation, the third indication information is carried in a packet data unit PDU session establishment request message, and the second indication information is carried in a PDU session establishment response message.

In a possible implementation, the processing module 1101 is further configured to indicate the communication module 1102 to send a first registration request message to the access and mobility management network element, where the first registration request message indicates that the terminal device supports a data service capability; and receive a first registration accept message from the access and mobility management network element, where the first registration accept message indicates that a network side supports the data service capability.

An example in which the communication apparatus 110 may be the terminal device in the foregoing method embodiments, or an apparatus including the foregoing terminal device, or a component that can be used in the terminal device is used.

The processing module 1101 is configured to: when detecting that a data service function is disabled, indicate the communication module 1102 to send fourth indication information to the data controller, where the fourth indication information is used to deregister a data service capability of the terminal device from the data controller.

In a possible implementation, the processing module 1101 is further configured to indicate the communication module 1102 to send a second registration request message to the access and mobility management network element, where the second registration request message indicates that the terminal device does not support the data service capability.

In a possible implementation, the processing module 1101 is further configured to: indicate the communication module 1102 to send a packet data unit PDU session release request message to the access and mobility management network element; receive a PDU session release command message from the access and mobility management network element; and send a PDU session release complete message to the access and mobility management network element.

For example, the communication apparatus 110 may be the access and mobility management network element in the foregoing method embodiments, or an apparatus including the foregoing access and mobility management network element, or a component that can be used in the access and mobility management network element.

The processing module 1101 is configured to: indicate the communication module 1102 to receive the third indication information from the terminal device, where the third indication information indicates to obtain the address information of the data controller; and send the second indication information to the terminal device, where the second indication information indicates the address information of the data controller.

In a possible implementation, the processing module 1101 is further configured to: indicate the communication module 1102 to send a first request message to a session management network element, where the first request message is used to request to obtain the address information of the data controller; and receive a first response message from the session management network element, where the first response message indicates the address information of the data controller.

In a possible implementation, the third indication information is carried in a packet data unit PDU session establishment request message, the second indication information is carried in a PDU session establishment response message, the first request message is carried in a PDU session context establishment request message, and the first response message is carried in a message in an N1N2 message transfer procedure.

All related contents of the steps in the foregoing method embodiments may be cited in function descriptions of the corresponding functional modules. Details are not described herein again.

Optionally, the module in FIG. 11 may also be referred to as a unit. For example, the processing module may be referred to as a processing unit, and the transceiver module may be referred to as a transceiver unit. In addition, in the embodiment shown in FIG. 11, a name of each unit may not be the name shown in the figure. For example, the transceiver module may also be referred to as a communication module or a communication unit.

When each unit in FIG. 11 is implemented in a form of software function module and sold or used as an independent product, the unit may be stored in a computer-readable storage medium. Based on such an understanding, the technical solutions in embodiments of this application essentially, or a part that makes a contribution to a conventional technology, or all or a part of the technical solutions may be embodied in a form of software product. The computer software product is stored in a storage medium, and includes several instructions for instructing a computer device (which may be a personal computer, a server, an access network device, or the like) or a processor to perform all or a part of the steps of the methods described in embodiments of this application. A storage medium for storing the computer software product includes any medium that can store program code, such as a USB flash drive, a removable hard disk, a read-only memory (ROM), a random access memory (RAM), a magnetic disk, or an optical disc.

In this embodiment of this application, the communication apparatus 110 is presented in a form of obtaining each functional module through division in an integrated manner. The module herein may be an ASIC, a circuit, a processor that executes one or more software or firmware programs, a memory, an integrated logic circuit, and/or another component capable of providing the foregoing functions. In a simple embodiment, a person skilled in the art may figure out that the communication apparatus 110 may be in a form of communication apparatus shown in FIG. 12.

Refer to FIG. 12. The communication apparatus includes a processor 1201 and a transceiver 1202. Optionally, the communication apparatus further includes a memory 1203 connected to the processor 1201.

The processor 1201 may be a general-purpose central processing unit (CPU), a microprocessor, an application-specific integrated circuit (ASIC), or one or more integrated circuits configured to control program execution of the solutions in this application. The processor 1201 may further include a plurality of CPUs, and the processor 1201 may be a single-CPU processor or a multi-CPU processor. The processor herein may be one or more devices, circuits, or processing cores configured to process data (for example, computer program instructions).

The processor 1201, the memory 1203, and the transceiver 1202 are connected through a bus. The transceiver 1202 is configured to communicate with another communication device. Optionally, the transceiver 1202 may include a transmitter and a receiver. A component configured to implement a receiving function in the transceiver 1202 may be considered as the receiver. The receiver is configured to perform a receiving step in embodiments of this application. A component configured to implement a sending function in the transceiver 1202 may be considered as the transmitter. The transmitter is configured to perform a sending step in embodiments of this application.

In a first possible implementation, as shown in FIG. 12, the communication apparatus further includes the memory 1203. The memory 1203 may be a ROM or another type of static storage device that can store static information and instructions, or a RAM or another type of dynamic storage device that can store information and instructions, or may be an electrically erasable programmable read-only memory (EEPROM), a compact disc read-only memory (CD-ROM) or another compact disc storage, an optical disc storage (including a compact optical disc, a laser disc, an optical disc, a digital versatile disc, a Blu-ray disc, or the like), a magnetic disk storage medium or another magnetic storage device, or any other medium that can be used to carry or store expected program code in a form of instructions or data structure and can be accessed by a computer. This is not limited in embodiments of this application. The memory 1203 may exist independently, or may be integrated with the processor 1201. The memory 1203 may include computer program code. The processor 1201 is configured to execute the computer program code stored in the memory 1203, to implement the method provided in embodiments of this application.

An embodiment of this application further provides a computer-readable storage medium, including instructions. When the instructions are run on a computer, the computer is enabled to perform any one of the foregoing methods.

An embodiment of this application further provides a computer program product including instructions. When the computer program product runs on a computer, the computer is enabled to perform any one of the foregoing methods.

An embodiment of this application further provides a chip, including a processor and an interface. The processor is coupled to a memory through the interface. When the processor executes a computer program or instructions in the memory, any one of the methods provided in the foregoing embodiments is performed.

An embodiment of this application further provides a communication system, including the terminal device, the data controller, the access network device, and the core network device in the foregoing embodiments.

All or a part of the foregoing embodiments may be implemented by using software, hardware, firmware, or any combination thereof. When a software program is used to implement embodiments, embodiments may be implemented completely or partially in a form of computer program product. The computer program product includes one or more computer instructions. When the computer program instructions are loaded and executed on the computer, the procedure or functions according to embodiments of this application are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL for short)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive (briefly referred to as an SSD)), or the like.

Although this application is described with reference to embodiments, in a process of implementing this application that claims protection, persons skilled in the art may understand and implement another variation of the disclosed embodiments by viewing the accompanying drawings, disclosed contents, and the accompanying claims. In the claims, “comprising” does not exclude another component or another step, and “a” or “one” does not exclude a case of multiple. A single processor or another unit may implement several functions enumerated in the claims. Some measures are recorded in dependent claims that are different from each other, but this does not mean that these measures cannot be combined to produce better effect.

Although this application is described with reference to features and embodiments thereof, it is clear that various modifications and combinations may be made to them without departing from the spirit and scope of this application. Correspondingly, the specification and accompanying drawings are merely example description of this application defined by the accompanying claims, and are considered as any of or all modifications, variations, combinations or equivalents that cover the scope of this application. It is clearly that a person skilled in the art can make various modifications and variations to this application without departing from the spirit and scope of this application. This application is intended to cover these modifications and variations of this application provided that they fall within the scope of protection defined by the following claims and their equivalent technologies.

The foregoing descriptions are merely implementations of this application, but are not intended to limit the protection scope of this application. Any variation or replacement within the technical scope disclosed in this application shall fall within the protection scope of this application. Therefore, the protection scope of this application shall be subject to the protection scope of the claims.

What is claimed is:

1. A communication method, applied to a terminal device and comprising:
obtaining address information of a data controller in response to detect that a data service function is enabled, wherein the data controller is configured to manage the data service function of the terminal device; and
sending first indication information to the data controller based on the address information of the data controller, wherein the first indication information is used to register a data service capability of the terminal device with the data controller.

2. The method according to claim 1, wherein obtaining the address information of the data controller comprises:
receiving second indication information from an access and mobility management network element, wherein the second indication information indicates the address information of the data controller; or
reading pre-configured address information of the data controller from the terminal device; or
reading pre-configured address information of the data controller from an identity card of the terminal device.

3. The method according to claim 2, wherein before receiving the second indication information from the access and mobility management network element, the method further comprises:
sending third indication information to the access and mobility management network element, wherein the third indication information indicates to obtain the address information of the data controller.

4. The method according to claim 3, wherein the third indication information is carried in a packet data unit (PDU) session establishment request message, and the second indication information is carried in a PDU session establishment response message.

5. The method according to claim 3, wherein before sending the third indication information to the access and mobility management network element, the method further comprises:
sending a first registration request message to the access and mobility management network element, wherein the first registration request message indicates that the terminal device supports the data service capability; and
receiving a first registration accept message from the access and mobility management network element, wherein the first registration accept message indicates that a network side supports the data service capability.

6. A communication method, applied to a terminal device and comprising:
sending fourth indication information to a data controller in response to detect that a data service function is disabled, wherein the fourth indication information is used to deregister a data service capability of the terminal device from the data controller.

7. The method according to claim 6, wherein the method further comprises:
sending a second registration request message to an access and mobility management network element, wherein the second registration request message indicates that the terminal device does not support the data service capability.

8. The method according to claim 6, wherein the method further comprises:
sending a packet data unit (PDU) session release request message to the access and mobility management network element;
receiving a PDU session release command message from the access and mobility management network element; and
sending a PDU session release complete message to the access and mobility management network element.

9. A communication apparatus, comprising a processor and a transceiver, wherein the processor is configured to:
obtain address information of a data controller in response to detect that a data service function is enabled, wherein the data controller is configured to manage the data service function of the communication apparatus; and
the transceiver is configured to send first indication information to the data controller based on the address information of the data controller, wherein the first indication information is used to register a data service capability of the communication apparatus with the data controller.

10. The communication apparatus according to claim 9, wherein
the processor is specifically configured to obtain second indication information received by the transceiver unit from an access and mobility management network element, wherein the second indication information indicates the address information of the data controller; or
the processor is specifically configured to read pre-configured address information of the data controller from the communication apparatus; or
the processor is specifically configured to read pre-configured address information of the data controller from an identity card of the communication apparatus.

11. The communication apparatus according to claim 10, wherein the transceiver is configured to send third indication information to the access and mobility management network element before receiving the second indication information from the access and mobility management network element, wherein the third indication information indicates to obtain the address information of the data controller.

12. The communication apparatus according to claim 11, wherein the third indication information is carried in a packet data unit (PDU) session establishment request message, and the second indication information is carried in a PDU session establishment response message.

13. The communication apparatus according to claim 11, wherein the transceiver is further configured to:
send a first registration request message to the access and mobility management network element before sending the third indication information to the access and mobility management network element, wherein the first registration request message indicates that the communication apparatus supports the data service capability;
and receive a first registration accept message from the access and mobility management network element, wherein the first registration accept message indicates that a network side supports the data service capability.

14. A communication apparatus, comprising a transceiver, wherein the transceiver is configured to:
send fourth indication information to a data controller in response to detect that a data service function is disabled, wherein the fourth indication information is used to deregister a data service capability of a terminal device from the data controller.

15. The communication apparatus according to claim 14, wherein the transceiver is further configured to send a second registration request message to an access and mobility management network element, wherein the second registration request message indicates that the terminal device does not support the data service capability.

16. The communication apparatus according to claim 14, wherein the transceiver is further configured to:
send a packet data unit (PDU) session release request message to the access and mobility management network element; receive a PDU session release command message from the access and mobility management network element;
and send a PDU session release complete message to the access and mobility management network element.
